(19) United States
(12) Patent Application Publication
(10) Pub. No.: US 2015/0338028 A1
(43) Pub. Date: Nov. 26, 2015

(54) LIGHT EMITTING DIODE BULB WITH CENTRAL AXIS BIDIRECTIONAL CONVECTION HEAT DISSIPATION STRUCTURE

(71) Applicant: SKYNET ELECTRONIC CO., LTD., Taipei (TW)

(72) Inventor: Jim-Hung LIANG, Taipei (TW)

(73) Assignee: SKYNET ELECTRONIC CO., LTD., Taipei (TW)

(21) Appl. No.: 14/814,611

(22) Filed: Jul. 31, 2015

Related U.S. Application Data
(63) Continuation of application No. 14/211,821, filed on Mar. 14, 2014.

(30) Foreign Application Priority Data
Dec. 23, 2013 (TW) 102147776

(51) Int. Cl. F21K 99/00; F21V 29/83; F21V 19/00; F21V 29/503; F21V 3/02; F21V 17/00

(52) U.S. Cl. CPC F21K 9/1355; F21V 3/02; F21V 17/002; F21V 19/004; F21V 29/503; F21V 29/83; F21Y 2101/02

(57) ABSTRACT

An LED bulb includes a lower cover having ventilation holes formed at outer periphery thereof, and a first coupling opening formed at top side thereof; a separating unit provided within the lower cover at a position between lower edges of the ventilation holes and bottom side of the lower cover, and having a convection pathway formed at top side thereof; a heat sink having bottom end positioned on top side of the separating unit; and an upper cover having top side formed with convection hole corresponding to top end of the heat sink, and a second coupling opening formed at bottom side thereof. When the second and first coupling openings are coupled with each other, the upper and lower covers are assembled together to form a central axis bidirectional convection heat dissipation pathway sequentially through the ventilation hole, the convection pathway, the heat sink and the ventilation hole accordingly.

### FIELD OF THE INVENTION

The present invention relates to a light emitting diode (hereinafter referred to as LED) bulb, more particularly to an LED bulb having a simplest structure along with a central axis bidirectional convection heat dissipation pathway formed therein, so that the LED bulb can be manufactured at a lowest cost and the massive amount of heat generated by LEDs inside the LED bulb can be quickly exchanged with cold ambient air outside the LED bulb through the heat dissipation pathway both in ways of thermal conduction and thermal convection, thereby effectively lower the temperature of the LEDs as well as effectively reducing luminous decay of the LEDs and extending the service life of the LED bulb. Moreover, since heat sink structure provided on the heat dissipation pathway is fully enclosed in the LED bulb, the LED bulb can keep the heat sink structure from being inadvertently touched by a user and effectively prevent the user from being burned.

### BACKGROUND OF THE INVENTION

Within the past decade, due to the manufacturing costs of high-brightness LEDs have lowered significantly, many light bulb manufacturers have employed LEDs as an illumination element to produce LED bulbs, with emphasis on environmental protection and energy efficiency. However, since the LED itself generates a non-negligible amount of heat during illumination, if an LED bulb cannot properly dissipate the massive amount of heat generated by the LEDs therein, the temperature of the LEDs will then be raised up to and stay at a very high level. A sustained high temperature can cause the materials of the LEDs to age prematurely, cause the LEDs to undergo luminous decay, and consequently cause a significant reduction in service life of the LED bulb. In order to improve the above problems, various heat dissipation structures for LED bulbs have been developed to enhance heat dissipation efficiency so as to extend the service lives of LED bulbs. However, most of the newly designed LED bulbs still have very complicate structures and can only be manufactured at very high costs which cause the selling prices thereof are unacceptable to ordinary consumers. Thus, most of the LED bulbs now existing in the market only have the names of saving energy and protecting the environment that are unsupported by facts.

One such complicate heat dissipation structure was developed by a U.S. company, namely “RAMBUS INC.”, and is described below with reference to FIG. 1:

(1) The LED bulb includes a heat dissipation housing A10, a bulb base A12, and a hollow light permeable cover A14. The heat dissipation housing A10 is made of aluminum alloy and integrally formed through metal molding. The bottom of the heat dissipation housing A10 defines an accommodating space therein for accommodating a driving circuit board (not shown). The heat dissipation housing A10 includes a plurality of heat dissipating fins A102 which extend outward, upward, and downward from the outer surface of the heat dissipation housing A10, where each two adjacent heat dissipating fins A102 are spaced apart by an interval forming a lighting area A1021 (as indicated by the dotted-line frames in the drawing). The bulb base A12 is provided at the bottom end of the heat dissipation housing A10 and has two electrodes separately electrically connected to the driving circuit board through wires. The portions of the heat dissipating fins A102 that extend in an upper part of the heat dissipation housing A10 surround and thereby define a mounting space which communicates with a lower convection hole A104 provided at the bottom end of the heat dissipation housing A10. The heat dissipation housing A10 is provided with a mounting platform (not shown) corresponding in position to the mounting space, where the mounting platform is mounted with an LED circuit board (not shown). The LED circuit board is provided with at least one LED A131 on its top surface and is electrically connected to the driving circuit board through wires. The hollow light permeable cover A14, which is made of glass or plastic and integrally formed, is configured to fit in the mounting space and be mounted around the mounting platform and the LED circuit board such that the light emitted by the LEDs A131 can project outward through the portions of the hollow light permeable cover A14 that correspond in position to the lighting areas A1021.

(2) After the LED circuit board and the hollow light permeable cover A14 are sequentially assembled into the mounting space in the upper part of the heat dissipation housing A10, it is required that an outer heat dissipation sleeve A15 be mounted in the hollow light permeable cover A14, where the outer heat dissipation sleeve A15 serves to absorb heat from the hollow light permeable cover A14. The outer heat dissipation sleeve A15 further has an inner dissipation sleeve A16 mounted therein. The inner heat dissipation sleeve A16 and the outer heat dissipation sleeve A15 are made of aluminum alloy and each integrally formed through metal molding. Both sleeves A15 and A16 are positioned on the mounting platform at their bottom sides and are hence connected to the heat dissipation housing A10 to increase the total area for heat dissipation. Finally, a fixing cover A17 is fixed to the top side of the inner heat dissipation sleeve A16. The fixing cover A17 is used to secure the hollow light permeable cover A14 and the outer heat dissipation sleeve A15 inside the mounting space and keep the inner heat dissipation sleeve A16 spaced apart from the outer heat dissipation sleeve A15 such that an upper convection hole A151 is formed between the two sleeves. The upper convection hole A151 communicates with the lower convection hole A104 through the mounting space to form a thermal convection pathway.

(3) Therefore, when the LEDs A131 emit light, the heat generated by the LEDs A131 can be first conducted to the mounting platform of the heat dissipation housing A10 through the bottom surface of the LED circuit board and then dispersed to ambient air through the heat dissipating fins A102 on the heat dissipation housing A10, the outer heat dissipation sleeve A15, and the inner heat dissipation sleeve A16 respectively, so as to lower the operating temperature of the LEDs A131, allowing the LEDs A131 to emit light of the intended color.

(4) After the LED bulb of RAMBUS is completely assembled, the heat dissipation housing A10, the outer heat dissipation sleeve A15, and the inner heat dissipation sleeve A16 are mutually connected to form a single unit, and all the heat dissipating fins A102 on the heat dissipation housing A10 are exposed on the outer periphery of the LED bulb. According to the principle of thermal conduction, heat is conducted through the path with the greatest temperature difference; therefore, most of the heat generated by the LEDs A131 is conducted to the heat dissipating fins A102 through the bottom surface of the LED circuit board and then dispersed into ambient air, rather than dissipating through the thermal convection pathway. As the temperature of the LEDs A131 increases and heat accumulates on the heat dissipating fins A102, the temperature of the heat dissipating fins A102 can reach an extremely high level, which may lead to a burn accident if the heat dissipating fins A102 are inadvertently touched. On the other hand, the thermal convection pathway between the upper convection hole A151 and the lower convection hole A104, although designed with great effort, contributes little to heat dissipation efficiency.

(5) In addition, in a completely assembled LED bulb of RAMBUS, the driving circuit board is disposed in the bottom of the heat dissipation housing A10. Hence, when most of the heat generated by the LEDs A131 is transferred to the heat dissipating fins A102 through the bottom surface of the LED circuit board, the same heat has been transferred to the bottom of the heat dissipation housing A10. Consequently, the temperature at the bottom of the heat dissipation housing A10 rises with the temperature of the LEDs A131, resulting in a significant increase in the temperature of the driving circuit board inside the heat dissipation housing A10. A sustained high temperature is bound to reduce the service life of the electronic components of the driving circuit board and thus greatly reduce the service life of the LED bulb.

In order to improve the drawbacks, such as the elements and structures are too complicate to be manufactured and assembled, existing in the above mentioned LED bulb, the inventor of the present invention has invented, but not yet disclosed, an LED bulb having a central axis bidirectional convection heat dissipation pathway formed therein, which is described below with reference to FIGS. 2 and 3:

(1) The LED bulb with a central axis bidirectional convection heat dissipation structure includes a housing 30, a heat sink 40, and a light permeable cover 50. The housing 30 includes a lower housing 31 and an upper housing 32, where the lower housing 31 defines an accommodating space 310 therein for accommodating a driving circuit board 33. The lower housing 31 is provided with an opening 311 on its top side, where the opening 311 is in communication with the accommodating space 310. The lower housing 31 is also provided with a bulb base 312 on its outer bottom side, where the two electrodes 3121 and 3122 of the bulb base 312 are separately electrically connected to the driving circuit board 33 and are separately electrically connectable to the two electrodes of an external power source (not shown) so as for the external power source to supply power to the driving circuit board 33, and for the driving circuit board 33 to process the received supply power to generate driving power.

(2) The upper housing 32 is provided with a first fixing plate 321 on its bottom side. The first fixing plate 321 is configured to be fixed to the opening 311 by adhesive bonding, by threaded connection, or by mutual engagement so that the driving circuit board 33 is enclosed in the accommodating space 310. The upper housing 32 is further provided with a second fixing plate 322 on its top side, where the second fixing plate 322 and the first fixing plate 321 are mutually connected, and at least one ventilation hole 34 is provided therebetween to communicate with the cold ambient air outside the LED bulb. The second fixing plate 322 is provided with a first convection hole 3221, where the first convection hole 3221 is in communication with the environment outside the LED bulb through the ventilation hole 34. Corresponding portions of the second fixing plate 322 and the first fixing plate 321 are each provided with at least one wire hole 35 such that the wire 331 of the driving circuit board 33 can pass sequentially through the wire holes 35 of the first and the second fixing plates 321 and 322 and become exposed from the top surface of the second fixing plate 322.

(3) The heat sink 40 is axially provided with and penetrated by a central axis hole 401. The inner wall surface of the central axis hole 401 may, depending on application requirements, be provided with a plurality of heat dissipating fins (not shown) extending along the axial direction of the central axis hole 401, where the heat dissipating fins also extend inward of and along the radial direction of the central axis hole 401 so as to increase the heat dissipation area of the heat sink 40. The bottom end of the heat sink 40 is positioned at the first convection hole 3221 such that the first convection hole 3221 is in communication with the central axis hole 401 inside the heat sink 40. There is at least one LED circuit board 41 attached to the outer side of the heat sink 40, where the LED circuit board 41 is electrically connected to the driving circuit board 33 through the wire 331 so as to receive the driving power transmitted from the driving circuit board 33 and drive the at least one LED 411 on the LED circuit board 41 to emit light.

(4) The light permeable cover 50 defines a receiving space 501 therein and forms a mounting opening 502 on its bottom side, where the mounting opening 502 is configured to be fixed to the top side of the second fixing plate 322 by adhesive bonding, by threaded connection, or by mutual engagement so that the heat sink 40 and the LED circuit board 41 are enclosed in the receiving space 501. The light permeable cover 50 is provided with a second convection hole 503 on its top side, and a portion of the light permeable cover 50 that is adjacent to the second convection hole 503 extends toward the receiving space 501 to form a positioning post 504. The second convection hole 503 passes through the positioning post 504 and communicates with the receiving space 501. The positioning post 504 is positioned at the top end of the heat sink 40 such that the ventilation hole 34, the first convection hole 3221, the central axis hole 401, and the second convection hole 503 are sequentially connected and jointly form a central axis bidirectional convection heat dissipation pathway, as shown in dotted line in FIG. 6. Thus, heat exchange can take place between the large amount of heat absorbed by the heat sink 40 from the LED circuit board 41 and from within the light permeable cover 50 and the cold ambient air outside the LED bulb not only by thermal conduction through the heat sink 40, but also by thermal convection through the central axis bidirectional convection heat dissipation pathway, as indicated by the arrows of FIG. 6 or in the opposite directions. This allows the high heat in the light permeable cover 50 and on the LED circuit board 41 to dissipate rapidly into ambient air to effectively lower the temperature, and reduce luminous decay, of the LEDs 411, thereby extending the service lives of the LEDs 411.

As stated above, the LED bulb structure invented by the present inventor as shown in FIGS. 2 and 3 can effectively increase the heat dissipation efficiency of the LEDs 411 in the LED bulb and enable heat exchange, by both thermal conduction and thermal convection, between the large amount of heat generated by the LED circuit board 41 (and the LEDs 411 thereon) and the cold ambient air outside the LED bulb, thus significantly enhancing the overall heat dissipation efficiency of the bulb without incurring extra costs. In terms of manufacture, however, the inventor has found that the configuration of the light permeable cover 50 hinders its being integrally formed of glass or plastic, and such difficulty in manufacture results in high production costs. To solve the problem that the LED bulb shown in FIGS. 2 and 3 cannot be easily integrally formed of glass or plastic, the present inventor came up with the idea of further simplifying the structure of the LED bulb, so as to enable the LED bulb to quickly exchange the massive amount of heat generated by LEDs therein with cold ambient air outside the LED bulb through the heat dissipation pathway both in ways of thermal conduction and thermal convection and, at the same time, to keep the heat sink structure from being inadvertently touched by a user, so as to achieve the primary objective of the present invention which effectively prevents the user from being burned due to in contact with the heat sink structure.

### BRIEF SUMMARY OF THE INVENTION

It is an objective of the present invention to provide an LED bulb with a central axis bidirectional convection heat dissipation structure. The LED bulb includes a lower cover, a separating unit, a heat sink and an upper cover. The lower cover is made of a non-thermally conductive or insulating material and is provided with a bulb socket on the outer bottom side of the lower cover. The lower cover is provided therein with a driving circuit board near the bottom side thereof, wherein the two electrodes of the bulb socket are separately and electrically connected to the driving circuit board, the outer periphery of the lower cover is provided with at least one ventilation hole so as to allow inside and outside of the lower cover to communicate with each other through the ventilation hole, and the top side of the lower cover is formed with a first coupling opening. The separating unit has a bottom side provided within the lower cover at a position between the lower edge of the ventilation hole and the driving circuit board, so as to confine the driving circuit board within the lower cover at a position near the bottom side of the lower cover, and a top side provided within the lower cover at a position between the upper edge of the ventilation hole and the first coupling opening, wherein the separating unit is formed with at least one convection pathway which can communicate with the top side of the separating unit and the ventilation hole, respectively. The heat sink is made of a thermally conductive material having a thermal conductivity coefficient higher than that of non-thermally conductive or insulating material, wherein the bottom end of the heat sink is positioned on the top side of the separating unit such that the heat sink can be in communication with the ventilation hole through the convection pathway, at least one LED circuit board is attached to the outer side of the heat sink, and the LED circuit board is electrically connected to the driving circuit board so as to drive at least one LED on the LED circuit board to emit light. The upper cover is made of a light permeable material, wherein the top side of the upper cover is formed with at least one convection hole, the top end of the heat sink is positioned in the upper cover and corresponds in position to the convection hole such that the heat sink is able to communicate with the cold ambient air outside the bulb by way of the convection hole, and the upper cover is formed with a second coupling opening at the bottom side thereof. The second coupling opening can be coupled with the first coupling opening such that the upper cover and the lower cover are assembled together to form a receiving space therebetween for accommodating the heat sink. The receiving space can communicate with the cold ambient air outside the bulb through a central axis bidirectional convection heat dissipation pathway formed by the ventilation hole, the convection pathway, the heat sink and the convection hole by ways of thermal conduction and thermal convection simultaneously. Since the heat sink and the separating unit provided thereon are fully enclosed in between the lower cover and the upper cover, it keeps the heat sink and the separating unit from being inadvertently touched by the user, so as to effectively avoid the user from being burned by the heat sink or the separating unit accordingly.

It is another objective of the present invention to provide the foregoing LED bulb, where the separating unit includes a base plate and a plurality of ventilation ribs integrally formed on the top side of the base plate. The base plate is provided within the lower cover at a position between the lower edge of the ventilation hole and the driving circuit board for confining the driving circuit board within the lower cover at a position near the bottom side of the lower cover, the bottom end of the ventilation rib is fixed to the top side of the base plate, and the top end of the ventilation rib extends to a position within the lower cover and between the upper edge of the ventilation hole and the first coupling opening. The ventilation ribs are configured to form the convection pathway for allowing the ventilation hole to communicate with the top side of the separating unit through the convection pathway.

It is still another objective of the present invention to provide the foregoing LED bulb, where the separating unit includes a first separating plate and a second separating plate. The first separating plate is provided within the lower cover at a position between the lower edge of the ventilation hole and the driving circuit board, so as to confine the driving circuit board within the lower cover at a position near the bottom side of the lower cover. The second separating plate is provided within the lower cover at a position between the upper edge of the ventilation hole and the first coupling opening. A ventilation space is formed between the second separating plate and the first separating plate and corresponds to the ventilation hole, for enhancing the ventilation efficiency. In addition, the second separating plate is formed with at least one penetrating hole thereon, for allowing the ventilation space to communicate with the penetrating hole to form the convection pathway and allowing the ventilation hole to communicate with the top side of the second separating plate through the convection pathway accordingly.

### BRIEF DESCRIPTION OF THE SEVERAL VIEWS OF THE DRAWINGS

The objectives as well as the structures and effects of the present invention will be best understood by referring to the following detailed description of some illustrative embodiments and the accompanying drawings, in which:

FIG. 1 is a perspective view of an LED bulb developed by RAMBUS INC.;

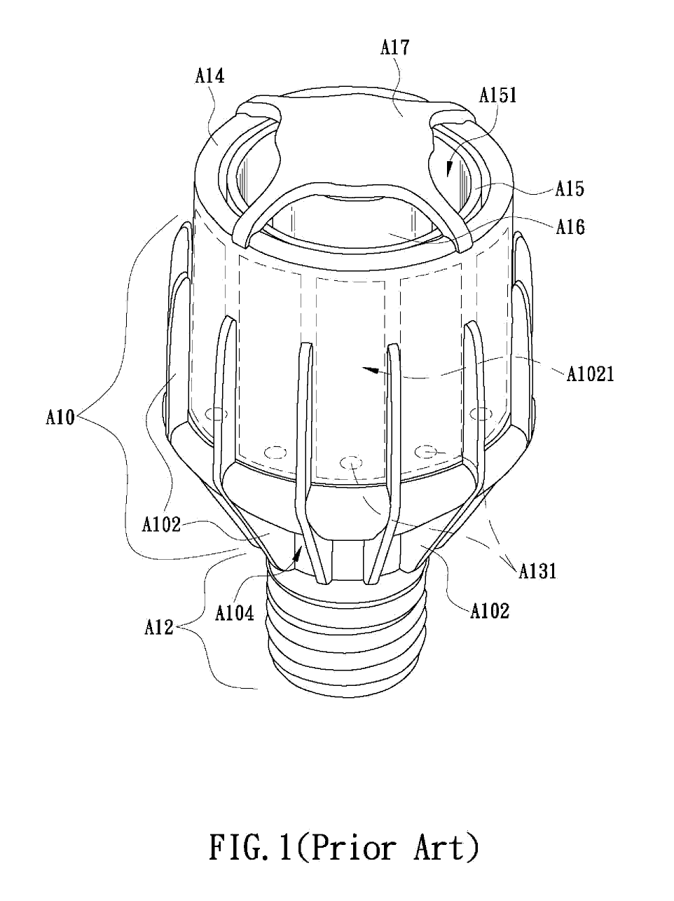

FIG. 2 is an exploded longitudinal sectional view of an LED bulb with a central axis bidirectional convection heat dissipation structure invented by the inventor of the present invention;

FIG. 3 is a perspective view of the LED bulb shown in FIG. 2;

FIG. 4 is an exploded longitudinal sectional view of an LED bulb with a central axis bidirectional convection heat dissipation structure in the first preferred embodiment of the present invention;

FIG. 5 is an assembled longitudinal sectional view of the first preferred embodiment of the present invention;

FIG. 6 is a cross sectional view of the heat sink shown in FIGS. 4 and 5.

FIG. 7 is an assembled perspective view of the first preferred embodiment of the present invention;

FIG. 8 is an assembled longitudinal sectional view of an LED bulb with a central axis bidirectional convection heat dissipation structure in the second preferred embodiment of the present invention;

### DETAILED DESCRIPTION OF THE INVENTION

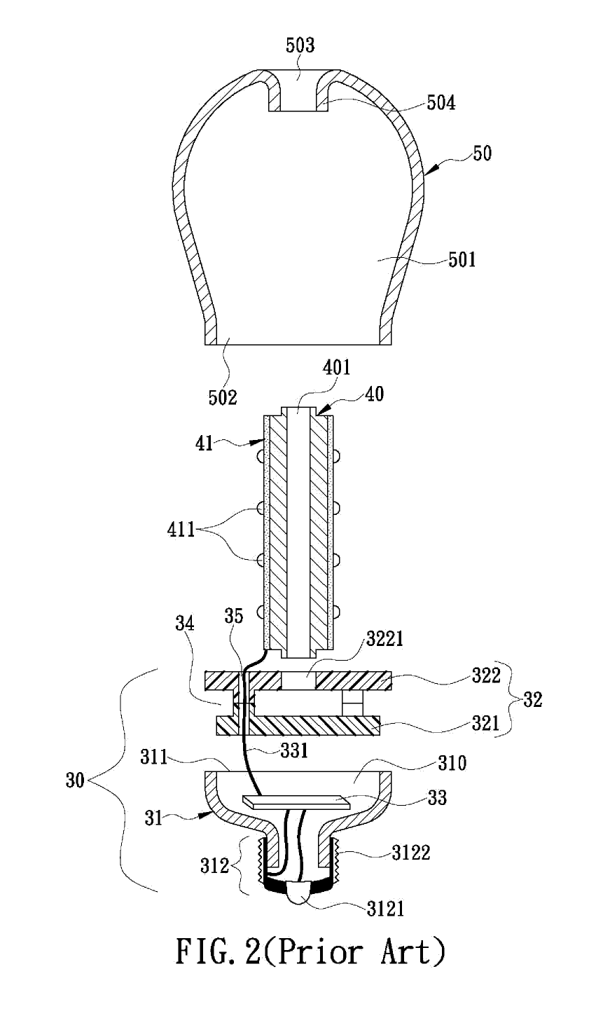

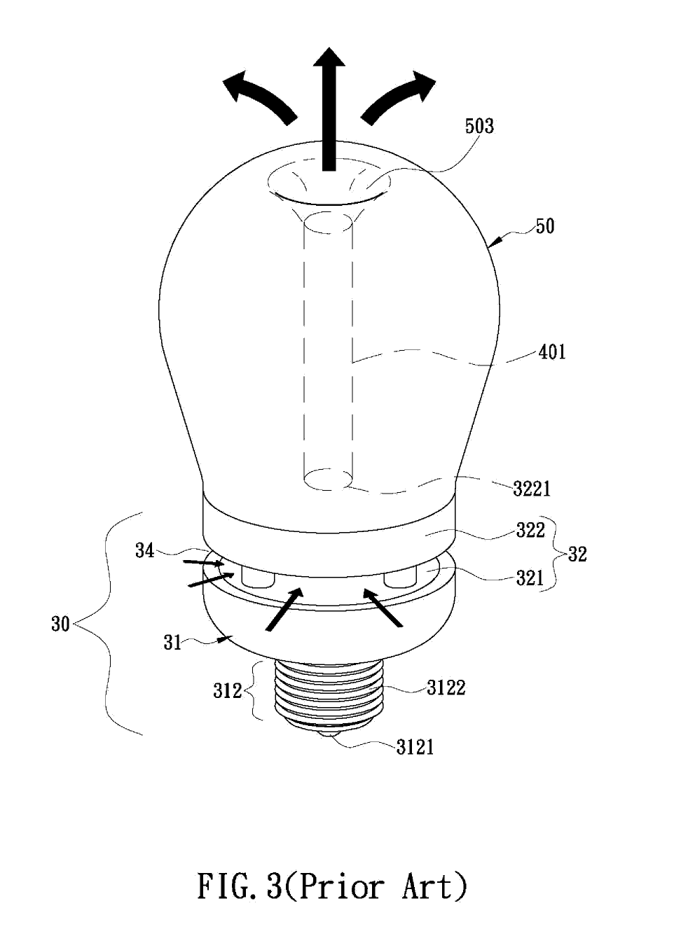

In order to solve the problem that the LED bulb shown in FIGS. 2 and 3 cannot be easily integrally formed of glass or plastic, the present inventor came up with the idea of dividing the light permeable cover into two parts, namely an upper cover and a lower cover, and having the lower cover integrally formed with the elements below. This novel design of LED bulb (having a simplest structure along with a central axis bidirectional convection heat dissipation pathway formed therein) will not only greatly reduce the difficulty in manufacture and consequently the production costs, but also effectively keep the heat sink structure formed therein from being inadvertently touched by a user and prevent the user from being burned since the heat sink structure provided on the heat dissipation pathway is fully enclosed in the LED bulb.

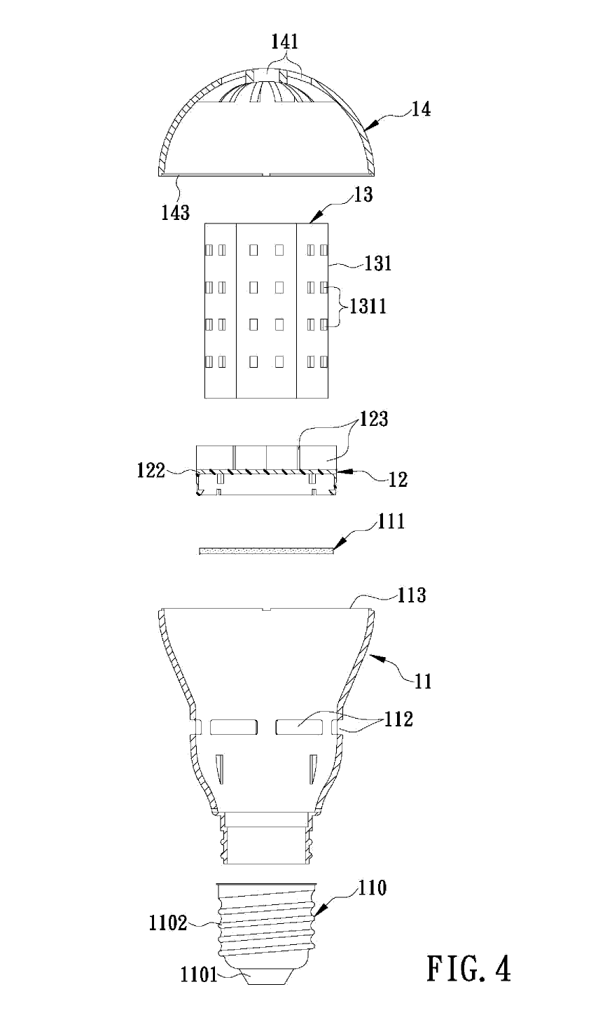

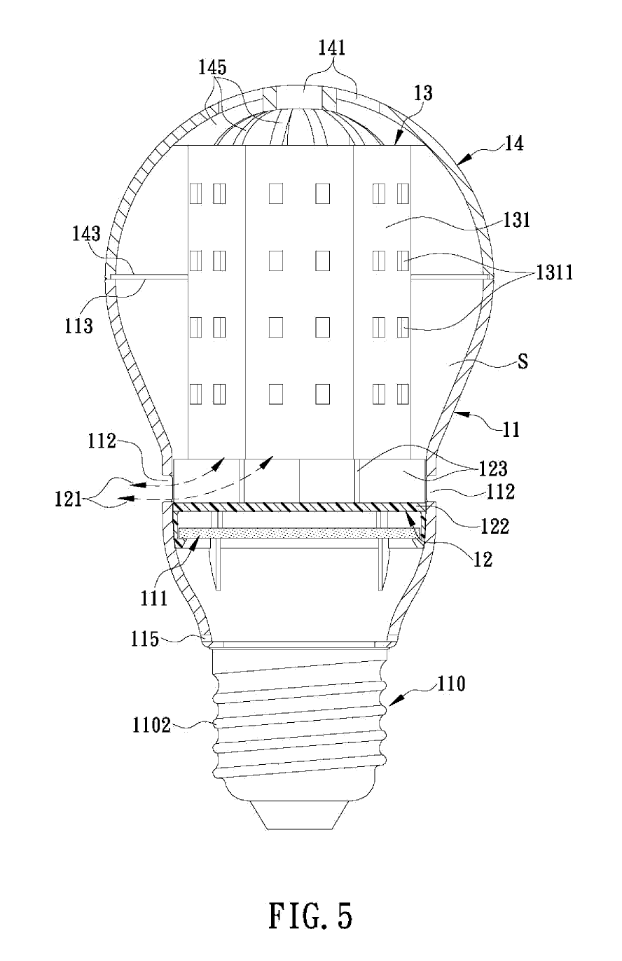

In a first preferred embodiment of the present invention, as referring to FIG. 4, the LED bulb with a central axis bidirectional convection heat dissipation structure of the present invention includes a lower cover 11, a separating unit 12, a heat sink 13 and an upper cover 14. The lower cover 11 is made of a non-thermally conductive or insulating material (e.g., plastic or ceramic) and is provided with a bulb socket 110 on the outer bottom side of the lower cover 11. As referring to FIGS. 4 and 5, the lower cover 11 is provided therein with a driving circuit board 111 near the bottom side thereof, wherein the two electrodes 1101 and 1102 of the bulb socket 110 are separately and electrically connected to the driving circuit board 111. The outer periphery of the lower cover 11 is provided with at least one ventilation hole 112, so as to allow inside and outside of the lower cover 11 to communicate with each other through the ventilation hole 112. The top side of the lower cover 11 is formed with a first coupling opening 113. The separating unit 12 is provided within the lower cover 11 and has a bottom side provided at a position between the lower edge of the ventilation hole 112 and the driving circuit board 111, so as to confine the driving circuit board 111 within the lower cover 11 at a position near the bottom side of the lower cover 11 and block heat transfer to the driving circuit board 111, thereby ensuring that the service life of the driving circuit board 111 will not end prematurely. The separating unit 12 has a top side provided within the lower cover 11 at a position between the upper edge of the ventilation hole 112 and the first coupling opening 113. The separating unit 12 is formed with at least one convection pathway 121 (as indicated by dotted lines each having arrows in opposite directions shown in FIG. 5), which can communicate with the top side of the separating unit 12 and the ventilation hole 112, respectively.

Again referring to FIGS. 4 and 5, the heat sink 13 in the first embodiment is made of a thermally conductive material having a thermal conductivity coefficient higher than that of non-thermally conductive or insulating material. The bottom end of the heat sink 13 is positioned on the top side of the separating unit 12 such that the heat sink 13 can be in communication with the ventilation hole 112 through the convection pathway 121. There is at least one LED circuit board 131 attached to the outer side of the heat sink 13, wherein the LED circuit board 131 is electrically connected to the driving circuit board 111 so as to receive the driving power transmitted from the driving circuit board 111 and drive at least one LED 1311 on the LED circuit board 131 to emit light. The upper cover 14 is made of a light permeable material, and has a top side formed with at least one convection hole 141. The top end of the heat sink 13 is positioned in the upper cover 14 and corresponds in position to the convection hole 141 such that the heat sink 13 is able to communicate with the cold ambient air outside the bulb by way of the convection hole 141. The upper cover 14 is formed with a second coupling opening 143 at the bottom side thereof. The second coupling opening 143 can be coupled with the first coupling opening 113 by adhesive bonding, by threaded connection, or by mutual engagement such that the upper cover 14 and the lower cover 11 are assembled together, as referring to FIG. 5, forming a receiving space S therebetween for accommodating the heat sink 13. The receiving space S can communicate with the cold ambient air outside the bulb through a central axis bidirectional convection heat dissipation pathway formed by the ventilation hole 112, the convection pathway 121, the heat sink 13 and the convection hole 141 by ways of thermal conduction and thermal convection simultaneously. In addition, the bottom side of the separating unit 12 is formed with at least one wire hole (not shown), allowing the wires of the driving circuit board 111 to extend into the receiving space S by sequentially passing through the corresponding wire hole in the separating unit 12 and electrically connect to the LED circuit board 131 so as to drive the LED 1311 to emit light.

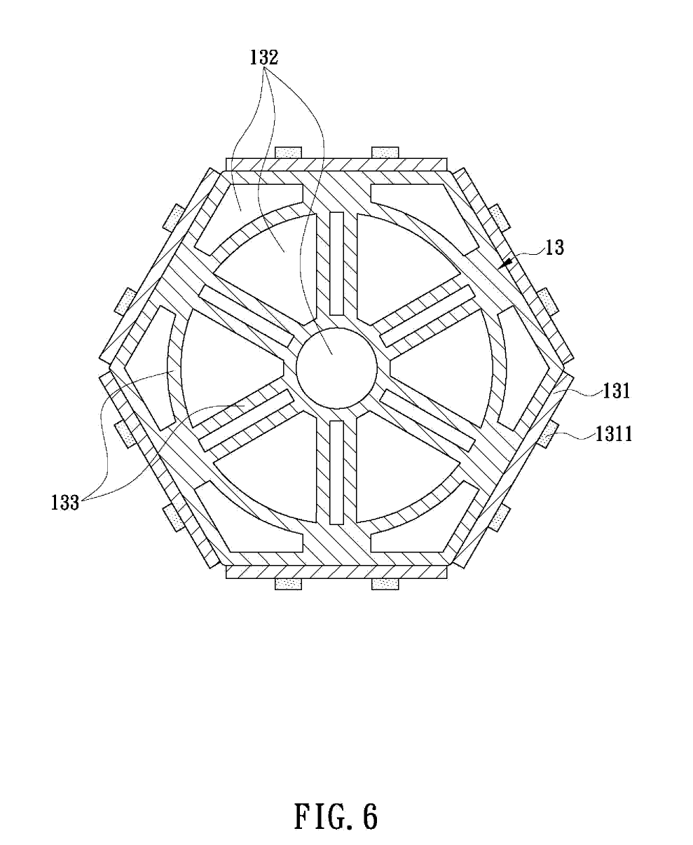

With reference to FIG. 6, the heat sink 13 in the first embodiment is made of a thermally conductive material such as aluminum alloy. The heat sink 13 is axially provided with and penetrated by a central axis hole 132. The inner wall surface of the central axis hole 132 may, depending on application requirements, be provided with a plurality of heat dissipating fins 133 extending along the axial direction of the central axis hole 132, wherein the heat dissipating fins 133 also extend radially inward of the central axis hole 132 so as to increase the heat dissipation area of the heat sink 13. Again referring to FIGS. 4 and 5, the bottom end of the heat sink 13 is positioned on the top side of the separating unit 12 and corresponds in position to the convection pathway 121 such that the convection pathway 121 is in communication with the bottom end of the central axis hole 132 in the heat sink 13. The top end of the heat sink 13 is positioned in the upper cover 14 and corresponds in position to the convection hole 141 such that the convection hole 141 is in communication with the top end of the central axis hole 132 in the heat sink 13.

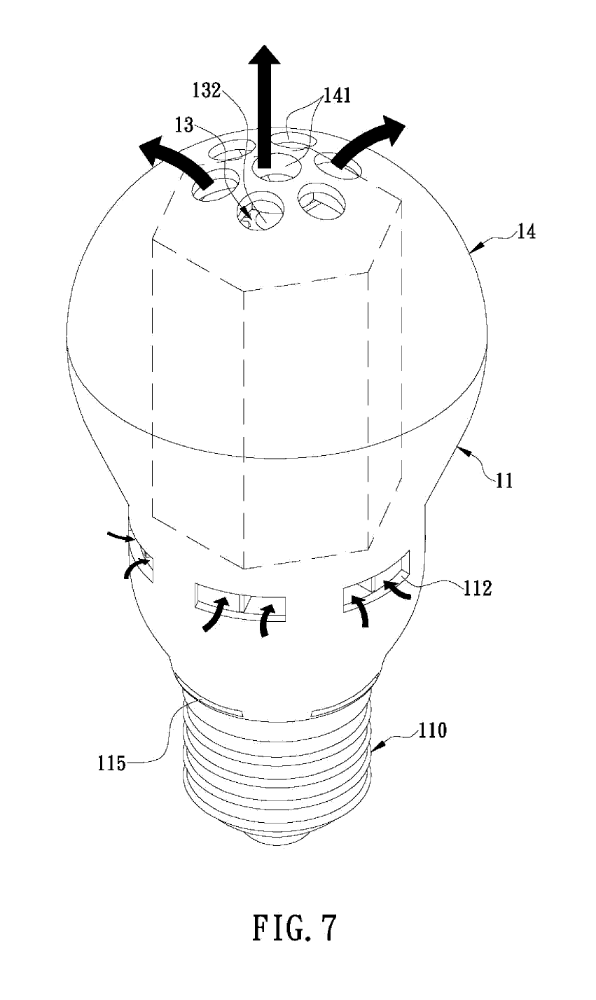

Once the LED bulb in the first preferred embodiment is fully assembled, as referring to FIGS. 5, 6 and 7, a central axis bidirectional convection heat dissipation pathway is formed by the ventilation hole 112, the convection pathway 121, the central axis hole 132, and the convection hole 141 sequentially connected together, as shown in dotted line in FIG. 7. Thus, heat exchange can take place between the large amount of heat absorbed from the LED circuit board 131 by the heat sink 13 and the cold ambient air outside the LED bulb not only by thermal conduction through the heat sink 13, but also by thermal convection through the central axis bidirectional convection heat dissipation pathway, as indicated by the arrows of FIG. 7 or in the opposite directions, so as to effectively lower the temperature of the LEDs 1311, reduce luminous decay of the LEDs 1311, and thereby extend the service lives of the LEDs 1311. In addition, since the separating unit 12, the heat sink 13 and the heat dissipating fins 133 thereon are completely enclosed in between the upper cover 14 and the lower cover 11, it not only effectively prevents the separating unit 12, the heat sink 13 and the heat dissipating fins 133 from being touched by a user, but also effectively avoids the user from being burn due to physical contact with the separating unit 12 or the heat sink 13. The embodiment described above is only one preferred embodiment of the present invention and is not intended to limit the scope of the present invention. The aforesaid thermally conductive material may alternatively be copper, other metals, or a plastic material containing a thermally conductive metal, provided that the thermally conductive material has a higher thermal conductivity than that of the upper cover 14, the lower cover 11 or the LED circuit board 131. Moreover, the heat sink 13 may be a solid member if both the convection pathway 121 and the convection hole 141 are large enough in diameter.

Again referring to FIGS. 4 and 5, in the first embodiment, the separating unit 12 includes a base plate 122 and a plurality of ventilation ribs 123 integrally formed on the top side of the base plate 122, wherein the base plate 122 is provided within the lower cover 11 at a position between the lower edge of the ventilation hole 112 and the driving circuit board 111 for confining the driving circuit board 111 within the lower cover 11 at a position near the bottom side of the lower cover 11, the bottom end of each ventilation rib 123 is fixed to the top side of the base plate 122, and the top end of each ventilation rib 123 extends to a position within the lower cover 11 and between the upper edge of the ventilation hole 112 and the first coupling opening 113. The ventilation ribs 123 are configured to form the convection pathway 121 for allowing the ventilation hole 112 to communicate with the top side of the separating unit 12 through the convection pathway 121.

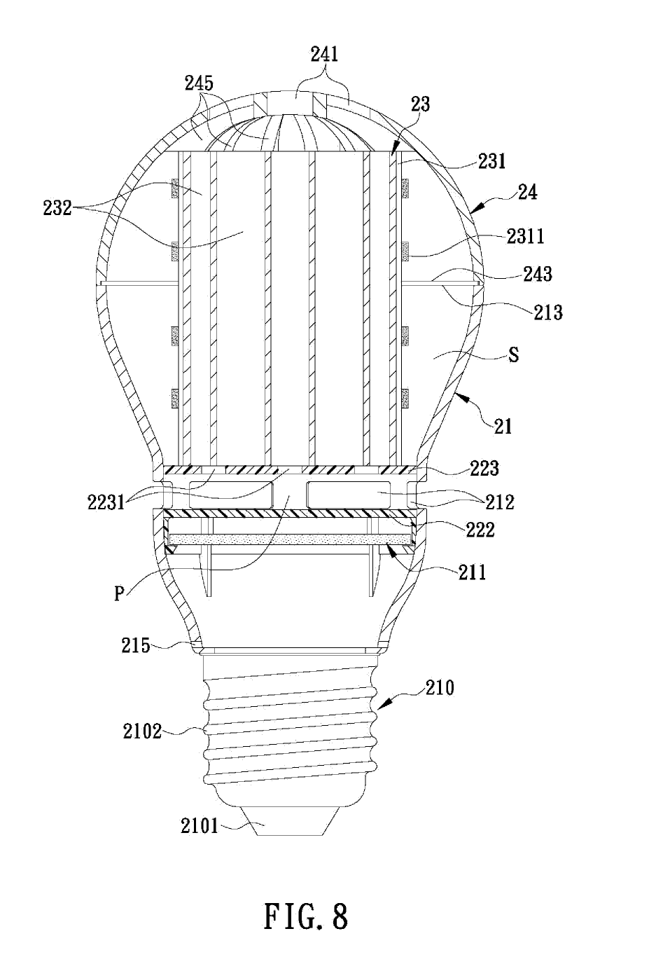

As referring to FIG. 8 of a second embodiment of the present invention, the LED bulb with a central axis bidirectional convection heat dissipation structure of the present invention includes a lower cover 21, a first separating plate 222, a second separating plate 223, a heat sink 23 and an upper cover 24, wherein a bulb socket 210 is provided on the outer bottom side of the lower cover 21, a driving circuit board 211 is provided within the lower cover 21 at a position near the bottom side of the lower cover 21, and two electrodes 2101 and 2102 of the bulb socket 210 are separately and electrically connected to the driving circuit board 211. The outer periphery of the lower cover 21 is provided with at least one ventilation hole 212, so as to allow inside and outside of the lower cover 21 to communicate with each other through the ventilation hole 212. The top side of the lower cover 21 is formed with a first coupling opening 213. The first separating plate 222 is made of a non-thermally conductive or insulating material and is provided within the lower cover 21 at a position between the lower edge of the ventilation hole 212 and the driving circuit board 211, so as to confine the driving circuit board 211 within the lower cover 21 at a position near the bottom side of the lower cover 21. The second separating plate 223 is made of a thermally conductive material and is provided within the lower cover 21 at a position between the upper edge of the ventilation hole 212 and the first coupling opening 213. The second separating plate 223 is separated with the first separating plate 222 by a distance, so as to form a ventilation space P between the second separating plate 223 and the first separating plate 222 for enhancing the ventilation efficiency. In addition, the second separating plate 223 is formed with at least one penetrating hole 2231 thereon, thereby allowing the ventilation space P to communicate with the penetrating hole 2231 for forming the convection pathway 121 as indicated in the first embodiment of the present invention and shown in FIG. 5. Thus, the ventilation hole 212 can be communicating with the top side of the second separating plate 223 through the convection pathway accordingly.

Again referring to FIG. 8, the bottom end of the heat sink 23 in the second embodiment is positioned on the top side of the second separating plate 223 and corresponds in position to the penetrating hole 2231 such that the central axis hole 232 in the heat sink 23 can communicate with the ventilation hole 212 through the penetrating hole 2231. The outer side of the heat sink 23 is attached with at least one LED circuit board 231, wherein the LED circuit board 231 is electrically connected to the driving circuit board 211 so as to receive the driving power transmitted from the driving circuit board 211 and drive at least one LED 2311 on the LED circuit board 231 to emit light. The top side of the upper cover 24 is formed with at least one convection hole 241. The top end of the heat sink 23 is positioned in the upper cover 24 and corresponds in position to the convection hole 241 such that the central axial hole 232 in the heat sink 23 is able to communicate with the cold ambient air outside the bulb by way of the convection hole 241. The bottom side of the upper cover 24 is formed with a second coupling opening 243 which can be coupled with the first coupling opening 213 such that the upper cover 24 and the lower cover 21 are assembled together to form a receiving space S therebetween for accommodating the heat sink 23. The receiving space S can also communicate with the cold ambient air outside the bulb through a central axis bidirectional convection heat dissipation pathway formed by the ventilation hole 212, the penetrating hole 2231, the central axis hole 232 and the convection hole 241 by ways of thermal conduction and thermal convection simultaneously.

It should be pointed out that, in each of the foregoing embodiments of the present invention, since the lower cover 11, 21 or the first separating plate 222 can be made of a non-thermally conductive or insulating material (e.g., plastic or ceramic), and the separating unit 12 or the second separating plate 223 can be made of a thermally conductive and fully enclosed in between the upper cover 14, 24 and the lower cover 11, 21, it ensures that the large amount of heat absorbed by the heat sink 13, 23 from the LED circuit board 131, 231 only undergoes heat exchange with the cold ambient air outside the bulb through the central axis bidirectional convection heat dissipation pathway, the separating unit 12 or the second separating plate 223, but is not conducted to the surface of the upper cover 14, 24 and the lower cover 11, 21 or to the driving circuit board 111, 211 therein. Therefore, burn accidents attributable to inadvertent physical contact with the lower cover 11, 21 are avoided, and the driving circuit board 111, 211 and the LED circuit board 131, 231 can be expected to work as long as designed.

Again referring to FIGS. 5, 6 and 8, in order to correctly position the top end of the heat sink 13, 23 into the upper cover 14, 24 at a position corresponding to the convection hole 141, 241 so as to ensure that the central axis hole 132, 232 in the heat sink 13, 23 can communicate with the cold ambient air outside the bulb through the convection hole 141, 241, the upper cover 14, 24 further includes at least one positioning rib 145, 245 formed at a position adjacent to the convection hole 141, 241 and extending toward the receiving space S, wherein an end of the positioning rib 145, 245 away from the upper cover 14, 24 is in contact against the top end of the heat sink 13, 23 so as to ensure that the heat sink 13, 23 is located at a correct position inside the LED bulb.

In addition, as referring to FIGS. 5, 7 and 8, in order to ensure that the isolating space within the lower cover 11, 21 for accommodating the driving circuit board 111, 211 also has a good heat dissipation efficiency, while the LED bulb is used in an environment without being required to be waterproof, the lower cover 11, 21 further includes at least one heat dissipating hole 115, 215 formed at a position corresponding to the isolating space so as to enhance the heat dissipation efficiency of the isolating space.

While the invention herein disclosed has been described by means of specific embodiments, numerous modifications and variations could be made thereto by those skilled in the art without departing from the scope of the invention set forth in the claims.

What is claimed is:

1. A light emitting diode (LED) bulb with a bidirectional convection heat dissipation structure, the LED bulb comprising:
a bulb socket having two electrodes;
a cover made of a light permeable material, and having a receiving space therein and a bottom side provided on a top side of the bulb socket, wherein the outer periphery of the cover adjacent to the bottom side thereof is provided with at least one ventilation hole, and a top side of the cover is formed with at least one convection hole, so as to allow air inside and outside of the cover to communicate with each other through the ventilation hole and convection hole;
a separating unit provided at a position between the lower edge of the ventilation hole and the bulb socket;
a driving circuit board provided at a position between the separating unit and the bulb socket, wherein the driving circuit board is electrically connected to the electrodes, respectively; and
at least one LED circuit board provided within the receiving space and electrically connected to the driving circuit board, wherein the bottom end of the LED circuit board is positioned on the top side of the separating unit such that the LED circuit board can communicate with the cold ambient air outside the bulb through a bidirectional convection heat dissipation pathway formed by the ventilation hole, the receiving space between the LED circuit board and the cover, and the convection hole.

2. The LED bulb of claim 1, wherein the separating unit has a top side provided within the receiving space at a position above the upper edge of the ventilation hole, and is formed with at least one convection pathway which can communicate with the top side of the separating unit and the ventilation hole, respectively, such that the LED circuit board can communicate with the cold ambient air outside the bulb through the bidirectional convection heat dissipation pathway formed by the ventilation hole, the convection pathway, the receiving space between the LED circuit board and the cover, and the convection hole.

3. The LED bulb of claim 2, wherein the separating unit includes:
a base plate provided at a position between the lower edge of the ventilation hole and the driving circuit board; and
a plurality of ventilation ribs each having a bottom end fixed to the top side of the base plate and a top end extending to a position within the receiving space and above the upper edge of the ventilation hole, wherein the ventilation ribs are configured to form the convection pathway for allowing the ventilation hole to communicate with the top side of the separating unit through the convection pathway.

4. The LED bulb of claim 2, the separating unit includes:
a first separating plate provided at a position between the lower edge of the ventilation hole and the driving circuit board; and
a second separating plate provided within the receiving space at a position above the upper edge of the ventilation hole, so as to form a ventilation space between the second separating plate and the first separating plate, wherein the second separating plate is formed with at least one penetrating hole thereon, thereby allowing the ventilation space to communicate with the penetrating hole for forming the convection pathway.

5. The LED bulb of claim 3, wherein the cover further includes at least one positioning rib formed at a position adjacent to the convection hole and extending toward the receiving space, wherein an end of the positioning rib away from the convection hole is in contact against the top end of the LED circuit board.

6. The LED bulb of claim 4, wherein the cover further includes at least one positioning rib formed at a position adjacent to the convection hole and extending toward the receiving space, wherein an end of the positioning rib away from the convection hole is in contact against the top end of the LED circuit board.

7. A light emitting diode (LED) bulb with a bidirectional convection heat dissipation structure, the LED bulb comprising:
a bulb socket having two electrodes;
a cover made of a light permeable material, and having a receiving space therein and a bottom side provided on a top side of the bulb socket, wherein the outer periphery of the cover adjacent to the bottom side thereof is provided with at least one ventilation hole, and a top side of the cover is formed with at least one convection hole, so as to allow air inside and outside of the cover to communicate with each other through the ventilation hole and convection hole;
a separating unit provided at a position between the lower edge of the ventilation hole and the bulb socket;
a driving circuit board provided at a position between the separating unit and the bulb socket, wherein the driving circuit board is electrically connected to the electrodes, respectively;
a heat sink provided within the receiving space and made of a thermally conductive material having a thermal conductivity coefficient higher than that of the cover, wherein the bottom end of the heat sink is positioned on the top side of the separating unit; and
at least one LED circuit board attached to the heat sink and electrically connected to the driving circuit board, such that the heat sink and the LED circuit board can communicate with the cold ambient air outside the bulb through a bidirectional convection heat dissipation pathway formed by the ventilation hole, the receiving space between the LED circuit board and the cover, and the convection hole.

8. The LED bulb of claim 7, wherein the separating unit has a top side provided within the receiving space at a position above the upper edge of the ventilation hole, and is formed with at least one convection pathway which can communicate with the top side of the separating unit and the ventilation hole, respectively, such that the heat sink and the LED circuit board can communicate with the cold ambient air outside the bulb through the bidirectional convection heat dissipation pathway formed by the ventilation hole, the convection pathway, the receiving space between the LED circuit board and the cover, and the convection hole.

9. The LED bulb of claim 8, wherein the separating unit includes:
a base plate provided at a position between the lower edge of the ventilation hole and the driving circuit board; and
a plurality of ventilation ribs each having a bottom end fixed to the top side of the base plate and a top end extending to a position within the receiving space and above the upper edge of the ventilation hole, wherein the ventilation ribs are configured to form the convection pathway for allowing the ventilation hole to communicate with the top side of the separating unit through the convection pathway.

10. The LED bulb of claim 8, wherein the separating unit includes:
a first separating plate provided at a position between the lower edge of the ventilation hole and the driving circuit board; and
a second separating plate provided within the receiving space at a position above the upper edge of the ventilation hole, so as to form a ventilation space between the second separating plate and the first separating plate, wherein the second separating plate is formed with at least one penetrating hole thereon, thereby allowing the ventilation space to communicate with the penetrating hole for forming the convection pathway.

11. The LED bulb of claim 9, wherein the cover further includes at least one positioning rib formed at a position adjacent to the convection hole and extending toward the receiving space, wherein an end of the positioning rib away from the convection hole is in contact against the top end of the heat sink.

12. The LED bulb of claim 10, wherein the cover further includes at least one positioning rib formed at a position adjacent to the convection hole and extending toward the receiving space, wherein an end of the positioning rib away from the convection hole is in contact against the top end of the heat sink.
